(19) United States
(12) Patent Application Publication
(10) Pub. No.: US 2016/0325319 A1
(43) Pub. Date: Nov. 10, 2016

(54) IN-SITUATION SCR CATALYST CLEANING PROCESS

(71) Applicant: Thompson Industrial Services, LLC, Sumter, SC (US)

(72) Inventor: Michael P. Ware, JR., Madison, IN (US)

(21) Appl. No.: 15/216,337

(22) Filed: Jul. 21, 2016

Related U.S. Application Data
(63) Continuation-in-part of application No. 14/667,364, filed on Mar. 24, 2015.
(60) Provisional application No. 61/967,601, filed on Mar. 24, 2014.

(51) Int. Cl. B08B 7/02; F01N 3/20; B08B 15/02; B08B 5/02; B08B 5/04

(52) U.S. Cl. CPC B08B 7/02; B08B 5/02; B08B 5/04; B08B 15/02; F01N 3/2066

(57) ABSTRACT

A vibration method of in situation cleaning of SCR catalyst units is disclosed. The system may include a hood that is designed to be manually positioned above the catalyst and pneumatic vibrators to be manually positioned under the catalyst layers to be used in concert with each other to manually clear the catalyst of built-up particle ash. The hood configuration blows and vacuums the ash from the top of the catalyst while the vibrators shake the ash loose from within the catalyst from the bottom of the catalyst modules.

### CROSS REFERENCE TO RELATED APPLICATIONS

This is a continuation-in-part application of U.S. patent application Ser. No. 14/667,364, filed Mar. 24, 2015 which claims benefit and priority to U.S. Provisional Patent Application No. 61/967,601, filed Mar. 24, 2014 titled “IN-SITUATION SCR CATALYST CLEANING PROCESS,” the disclosures of which is hereby incorporated herein by reference in its entirety.

### BACKGROUND OF THE DISCLOSURE

1.0 Field of the Disclosure

The present disclosure relates generally to industrial emissions/equipment and cleaning thereof and, more particularly, to a system and method for SCR catalyst cleaning methods, among other features.

2.0 Related Art

Selective catalytic reduction (SCR) is a means of converting nitrogen oxides with the aid of a catalyst into, e.g., diatomic nitrogen, N2, and water, H₂O. A gaseous reductant, typically anhydrous ammonia, aqueous ammonia, is added to a stream of flue or exhaust gas and is absorbed onto a catalyst. Carbon dioxide is a reaction product when the ammonia is used as the reductant.

Commercial selective catalytic reduction systems are typically found on large utility boilers, industrial boilers, municipal solid waste boilers and, particularly, coal-fired power plants.

In Coal-fired power plant applications a “SCR UNIT” houses typically 2-3 layers of catalyst. Each layer of catalyst is made-up of catalyst modules and supported with an I-beam monorail system, or similar support structure. Flue gas containing fly ash passes through the catalyst layers, which causes the nitrogen oxides to react with the ammonia. The reaction causes the nitrogen to be converted to water vapor that is then released into the air. However, the design of an SCR system is challenged due to particulate in the fly ash that frequently causes the catalyst to become blocked/blinded thereby restricting the flow of gas through the catalyst and preventing optimal performance.

Current in-situation methods of maintaining SCR catalyst only include clearing the tops of the catalyst by merely vacuuming the ash off of the tops of the catalyst. However, current methods are not adequately preventing catalyst blockage/blinding. As a result, the catalyst often becomes severely clogged and eventually need to be removed manually to be cleaned and often regenerated. All current methods of cleaning/unclogging catalyst, once preventive maintenance has failed, involve taking the boiler off-line, thereby preventing the plant from providing power to the grid.

Current EPA standards make SCR optimization more necessary than ever. Increasing demand for power prevents frequent plant shut down. Cost of plant shut down, removal of catalyst and catalyst cleaning is staggering in comparison to the methods introduced with this invention.

### SUMMARY OF THE DISCLOSURE

The present disclosure includes a method and/or system of cleaning the SCR unit, while the unit is on (vibrator only), or off-line (vibrator and hood), and cleaning the SCR catalyst, in-situation. This disclosure provides a design or configuration of special equipment, including a hood that is designed to be manually positioned above the catalyst and pneumatic vibrators to be manually positioned under the catalyst layers to be used in concert with each other to manually clear the catalyst of built-up particle ash. The hood configuration blows and vacuums the ash from the top of the catalyst while the vibrators shake the ash loose from within the catalyst from the bottom of the catalyst modules.

In one aspect, a method for cleaning a selective catalytic reduction (SCR) unit is provided and includes the steps of positioning a hood above a catalyst module, the hood configured to blow air and configured to vacuum a top of the catalyst module and positioning and connecting a pneumatic vibrator under the catalyst module, wherein the hood and pneumatic vibrator operationally clear the catalyst module of built-up particle ash.

In one aspect, a system for cleaning a selective catalytic reduction (SCR) unit is provided comprising a hood configured to be positioned above one or more catalyst modules, a pneumatic vibrator configured to be configured under the one or more catalyst modules, wherein the hood is configured to apply air pressure to clean the one or more catalyst modules while the pneumatic vibrator is configured to simultaneously vibrate the one or more catalyst modules for cleaning the SCR unit.

In one aspect, a method for cleaning a selective catalytic reduction (SCR) unit during an off-line mode of a SCR system includes positioning a hood having a plurality of mate-able sections above a catalyst module, the hood configured to blow air and configured to vacuum a top of the catalyst module, the hood sized to enclose a top of the catalyst module and connecting at least one pneumatic vibrator to a frame element of a support system under the catalyst module, wherein the hood and pneumatic vibrator operationally clear the catalyst module of built-up particle ash. The plurality of mate-able sections may be each sized to permit individual entry into the SCR system. The plurality of mate-able sections may each be sized to permit individual entry into a SCR system, whereas the mated sections mated together being too large to permit entry into the SCR system. In the positioning step, each of the plurality of mate-able sections may be configured with at least one air-line spanning across an inner surface of each of the plurality of mate-able sections. In the positioning step, at least one of the plurality of mate-able sections may be configured with a vacuum port for imparting a suction on the catalyst module. The method may further include activating the suction (or vacuum) and the at least one pneumatic vibrator so that the suction (or vacuum) and pneumatic vibrator operate at a common period of time. The step for connecting at least one pneumatic vibrator may connect the at least one pneumatic vibrator by one of: bolting, welding and clamping. The step for connecting at least one pneumatic vibrator may connect the at least one pneumatic vibrator to a metallic beam under the catalyst module. The step for connecting at least one pneumatic vibrator may connect a plurality of pneumatic vibrators.

In one aspect, a system for cleaning a selective catalytic reduction (SCR) unit during an off-line mode of a SCR system includes a hood having a plurality of mate-able sections, the hood configured with at least one air line for blowing air and configured to accept a vacuum line, the hood sized configured to be positionable to enclose a top of the catalyst module and at least one pneumatic vibrator connectable to a frame element of a support system under the catalyst module, wherein the hood and pneumatic vibrator are configured to operationally clear the catalyst module of built-up particle ash. The plurality of mate-able sections may each be sized to permit individual entry into the SCR system. The plurality of mate-able sections may be each sized to permit individual entry into a SCR system, and the mated sections together being too large to permit entry into the SCR system. Each of the plurality of mate-able sections may be configured with at least one air line spanning across an inner surface of each of the plurality of mate-able sections. At least one of the plurality of mate-able sections may be configured with a vacuum port for imparting a suction on the catalyst module. At least one pneumatic vibrator may connect the at least one pneumatic vibrator by one of: bolting, welding or clamping. The at least one pneumatic vibrator may connect the at least one pneumatic vibrator to a metallic beam under the SCR unit and catalyst module. The at least one pneumatic vibrator may comprise a plurality of pneumatic vibrators.

In one aspect, a method for cleaning a selective catalytic reduction (SCR) unit during an on-line or off-line mode of a SCR system includes connecting at plurality of pneumatic vibrators to a support system under a catalyst module and activating the at plurality of pneumatic vibrators to clear at least in part the catalyst module of built-up particle ash. The plurality of pneumatic vibrators may be attached on different beams of the support system.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the invention in more detail than may be necessary for a fundamental understanding of the disclosure and the various ways in which it may be practiced.

FIG. 1 is a partial cut-away view of an example SCR reactor, configured according to principles of the disclosure.

FIG. 2A is an illustration of example hood sections that is configured to be mated and placed over a SCR unit, configured according to principles of the disclosure.

FIG. 2B is an illustration of an example hood section showing a close-up of air components, configured according to principles of the disclosure.

FIG. 2C is a bottom view of an example hood sections in a mated configuration, configured according to principles of the disclosure.

FIG. 2D is a top view of an example hood sections in a mated configuration, configured according to principles of the disclosure.

FIG. 3 is a drawing of an example SCR unit and installed hood and installed vibrator, configured according to principles of the disclosure.

FIG. 4 is a drawing of an example pneumatic vibrator that is configured to be connected to a support system under the SCR unit, configured accordant to principles of the disclosure.

FIG. 5 is a top view of a SCR module, configured according to principles of the disclosure.

FIG. 6 is a perspective view of a SCR module, configured according to principles of the disclosure.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawing are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The term “about” means within +/−10% unless context indicates otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The selective catalytic reduction (SCR) reactor 100 as described herein may be used with, but not limited to, large utility boilers, industrial boilers, municipal solid waste boilers and, in particular, coal-fired power plants.

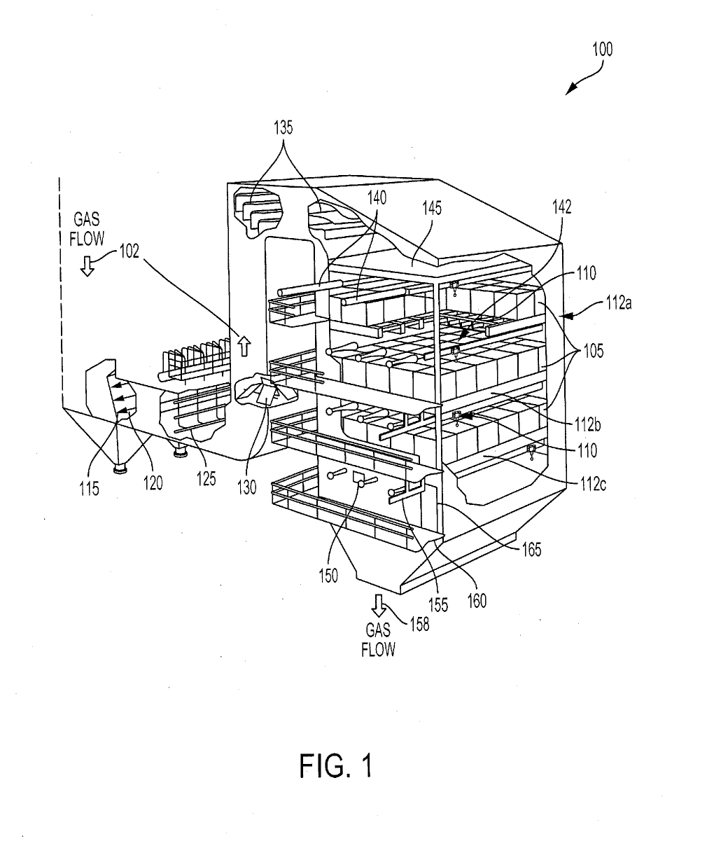

FIG. 1 is a partial cut-away view of an example selective catalytic reduction (SCR) reactor 100, configured according to principles of the disclosure. Other configurations may be used or encountered, as one of ordinary skill in the art would know. The SCR reactor 100 may include many components some of which include, but not limited to, a plurality of SCR units 105 arranged in multiple layers 112a-112c in a gas flow containment area 142. Each layer 112a-112c may have a support system 110 comprising, e.g., a beam structure such as a plurality of I-beams. The plurality of SCR units 105 may be arranged and supported by a respective separate support system 110.

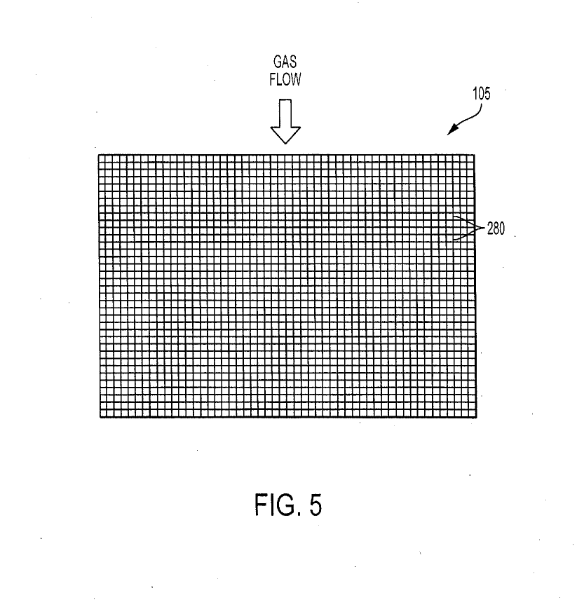

The selective catalytic reduction (SCR) reactor 100 may further include a rapper system 115 and large particle ash (LPA) screen 120 for initial ash removal that may accumulate as gas flows 102 during operation from a boiler area (not shown) into the SCR reactor 100. An ammonia injection grid may inject ammonia into the gas flow or exhaust gas to act as a reductant, and mixed by gas mixer. The gas flow may continue towards the plurality of SCR units 105 and turned by turning vanes 135 to direct the gas flow into and through flow straighteners 145 directing gas flow downward into the stacked layers 112a-112c of the plurality of SCR units 105 in an evenly distributed manner. There may be one or more modules 111 (FIG. 5) of catalyst placed together to form a layer of catalyst within the SCR unit 105. In embodiments, the SCR catalyst may be made from various ceramic materials used as a carrier, such as titanium oxide; and active catalytic components may be, e.g., oxides of base metals (such as, e.g. vanadium, molybdenum and tungsten) zeolites or various precious metals.

The selective catalytic reduction (SCR) reactor 100 may further include an access door 150 for personnel to gain entry into the containment space 142 and/or SCR units 105, such as for maintenance purposes. A different access door 150 may be positioned at each level of the SCR system proximate stacked layers 112a-112c, usually along a gantry or walk-way. The access door 150 typically is restrictive in size and typically will not permit a monolithic hood to pass therethrough. However, a hood 200 having a plurality of separate but mate-able portions 205, 210, described more below, can individually pass as separate detached portions through the access door 150, and thereafter be assembled to functionally act as if it were essentially a monolithic hood, once through the access door 150 for positioning on an SCR unit 105.

The selective catalytic reduction (SCR) reactor 100 may further include a catalyst loading door 165, a sonic horn 155 for alerting personnel to process issues. Generally, during operation of the SCR reactor 100 and associated boiler or plant, the gas flow 102 from a boiler or plant may flow into the SCR reactor 102 through the SCR units 105 and exit 158.

The SCR units 105 facilitate removal or minimization of NOx emissions. The catalyst 111 (FIG. 5) within the SCR units 105 may comprise a honeycomb-type or plate-type geometry. Other geometries may be possible.

During maintenance of the SCR units 105, while the system 100 is off-line and not operational, technicians may enter the inside of the system 110 and one or more of the SCR units 105 to vacuum off the fly ash that may be piled on top the catalyst 111. After loose ash is vacuumed, one or more pneumatic vibrators 260 may be secured to the support system 110, typically a beam under the SCR units 105. The pneumatic vibrators 260 may be connected such as, e.g., by bolting, clamping or welding to the support system 110. The pneumatic vibrators 260 may be fastened to a beam under or proximate to the SCR unit 105 to be cleaned by vibration treatment. In some embodiments, the pneumatic vibrators 260 may also be operated intermittently while the system 100 is in operation.

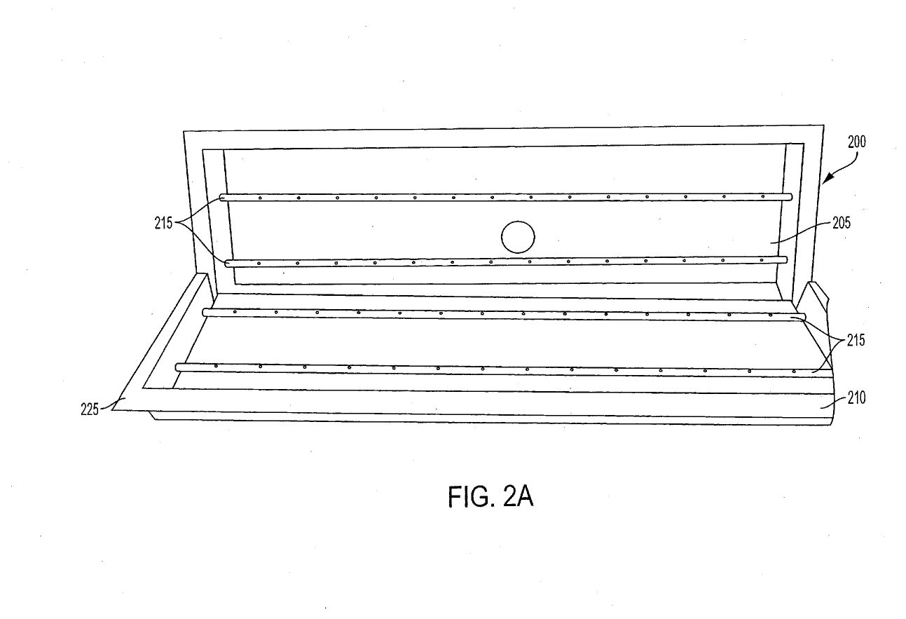

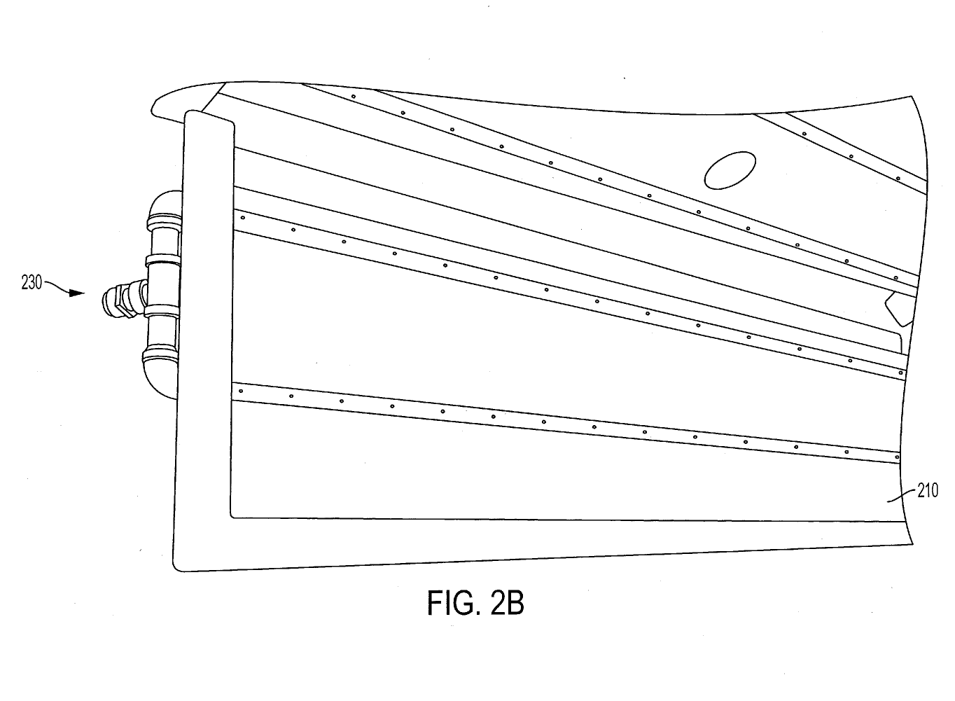

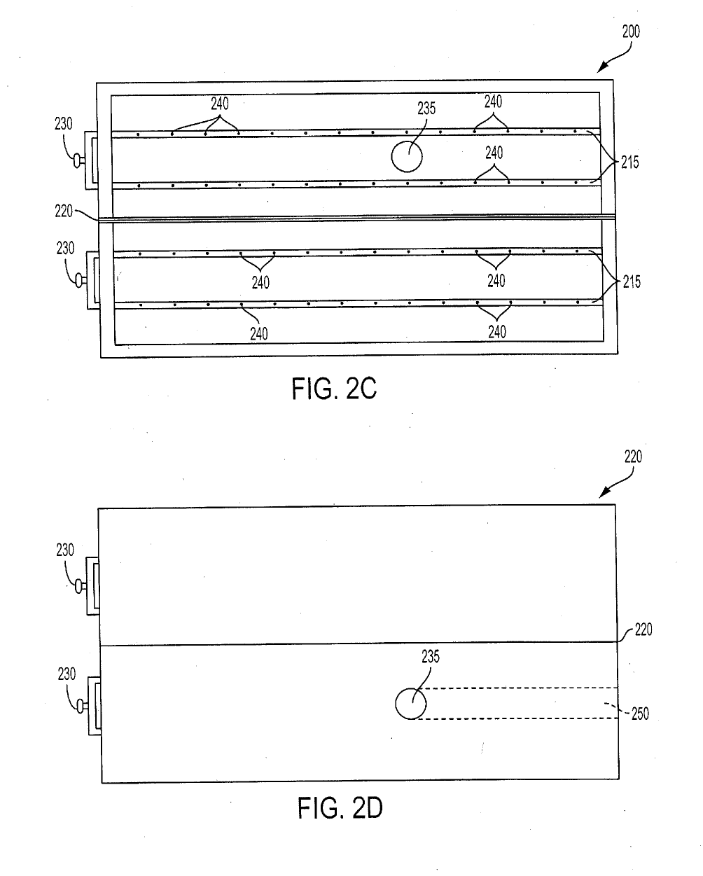

FIG. 2A is an illustration of example hood sections that is configured to be mated and placed over a SCR unit, configured according to principles of the disclosure. The hood sections 205, 210 may be configured to engage one another along one mutual sides so that the sections 205, 210 mate and are secured to one another. In one embodiment, the mating may not result in the sections being secured to one another. The sections 205, 210 may have raised edges 220, 225 along the perimeter of the hood sections 205, 210 to create a depth within the hood sections. Air lines 215 may be arranged along a length of each hood section 205, 210, within the depth created by the raised edges 220, 225.

FIG. 2B is an illustration of an example hood section showing a close-up of air components, configured according to principles of the disclosure. Air lines 215 may be connected to a gas connections adaptors 230 external to each the hood sections 205, 210.

FIG. 2C is a bottom view of an example hood sections in a mated configuration, configured according to principles of the disclosure. Air lines 215 may be connected to air adaptors 230. The adaptors 230 may receive an external pressurized air source for delivering an air flow to the air vents 240. Air vents 240 may be arranged at intervals along each air-line 215.

FIG. 2D is a top view of an example hood sections in a mated configuration, configured according to principles of the disclosure. A vacuum port may be configured in one hood section 205, 215. In one embodiment, each section 205, 215 may have a vacuum port 235, each closable, if one is not required. A vacuum line 250 may be connected to the vacuum port 235 for providing suction to the SCR unit 105 during vacuuming operation.

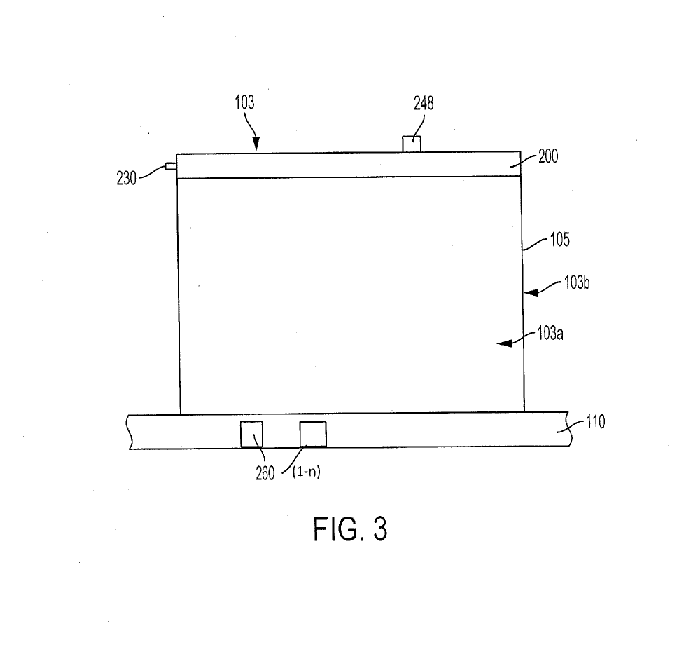

FIG. 3 is a drawing of an example SCR unit and installed hood and installed vibrator 260, configured according to principles of the disclosure. Multiple vibrators 260 may be employed on a same beam or on different beams. Moreover, multiple vibrators 260 may be employed simultaneously under multiple SCR units 205 and operated simultaneously or sequentially. In one embodiment, multiple vibrators 260 may be employed while the SCR system 100 is in operation (without use of hoods 200).

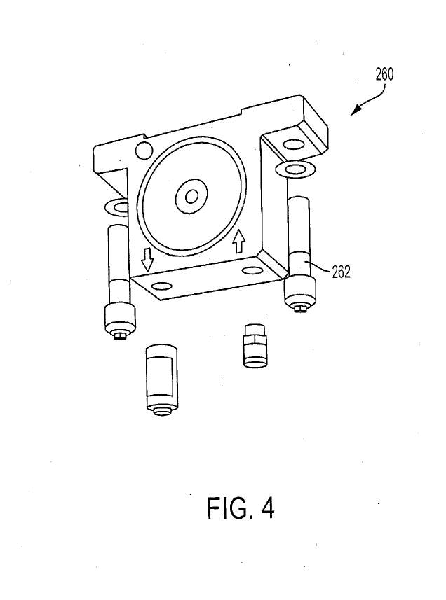

FIG. 4 is a drawing of an example pneumatic vibrator that are configured to be fix to a support system under the SCR unit, configured accordant to principles of the disclosure. In this example, the pneumatic vibrator 260 may be secured to a support structure, e.g., a beam, by one or more bolts 262.

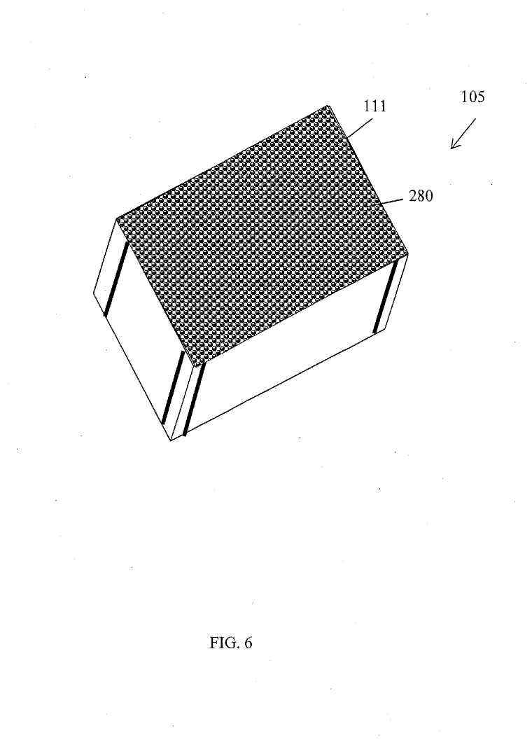

FIG. 5 is a top view of a SCR module showing catalyst material 111 therein, configured according to principles of the disclosure. FIG. 6 is a perspective view of a SCR module 105 with catalyst material therein, configured according to principles of the disclosure.

Accumulated particulate in the SCR units 105 may become heavy and may be plugging the openings 280 of catalyst 111 in SCR units 105, and a simple vacuuming may be insufficient to clear the accumulated particulate. The openings 280 may be passageways with geometries related to the type of particular implementation.

While the SCR system 100 is off-line, technicians, or similar personnel, may position the hood 200, e.g., hood as shown in FIGS. 2A-2D, at the incoming gas flow side of an SCR unit 105. In the example of FIG. 5, the hood 200 may be positioned to cover the opening at the top of the SCR unit 105, where the gas flow encounters the SCR unit 105. The vacuum line 250 may be attached to the hood 120 via opening 235 to vacuum the ash that may be loosening during the cleaning process. Air lines (not shown) may connect to adaptors 230 along the hood 200 to provide air to the air lines 215 to blow air out air holes 240 towards the catalyst 111 and openings 280 within the SCR module 105.

The steps of a method according to principles of the disclosure may include applying the hood 200, (which may blow air at high volume and may vacuum the tops of the catalyst), and attaching and activating the vibrators, (which shake the ash loose from the catalyst 111 and possibly the internal walls of the SCR unit 105). In other embodiments, the hood 200 may be configured in size to fit the catalyst baskets or SCR unit 105, as commonly employed in the industry. The hood 200 may have one 4-6″ (approx.) opening for the vacuum line and four fittings (the number of fittings may vary) for the air pressure lines. Under or within the hood 200 there may be a plurality of pipes running from each air-line distributing the air pressure directly to the SCR module 105 However, this disclosure uses the hood configuration to blow and vacuum the ash from the top of the catalyst while pneumatic vibrators 135 may be used to shake the ash loose from within the SCR units 105, the vibration originating from the bottom of the SCR units 105.

In one example, the present disclosure includes a method of in-situation vibration cleaning of SCR catalyst within coal-fired boilers employing this blow-down/shake-down method using air and vacuum from the top of the SCR units 105 and pneumatic vibration from the bottom. Both the hood 200 and the vibrators 260 can be used together or separately to produce better cleaning of the catalyst over conventional in-situ methods. In one embodiment, the virbrators 260 may be used alone (i.e., without the hood 200) during active SCR system 100 operations.

While the foregoing written description enables one of ordinary skill to make and use what is considered presently to be the best mode thereof, those of ordinary skill will understand and appreciate the existence of variations, combinations and equivalents of the specific method, and examples herein. The disclosure should therefore not be limited by the above described embodiment, method, and examples, but by all examples and methods within the scope and spirit of the invention as claimed.

What is claimed:

1. A method for cleaning a selective catalytic reduction (SCR) unit during an off-line mode of a SCR system, the method comprising:
positioning a hood having a plurality of mate-able sections above a catalyst module, the hood configured to blow air and configured to vacuum a top of the catalyst module, the hood sized to enclose a top of the catalyst module; and
connecting at least one pneumatic vibrator to a frame element of a support system under the catalyst module,
wherein the hood and pneumatic vibrator operationally clear the catalyst module of built-up particle ash.

2. The method of claim 1, wherein the plurality of mate-able sections are each sized to permit individual entry into the SCR system.

3. The method of claim 1, wherein the plurality of mate-able sections are each sized to permit individual entry into a SCR system, and the mated sections mated together being too large to permit entry into the SCR system.

4. The method of claim 1, wherein in the positioning step, each of the plurality of mate-able sections is configured with at least one air line spanning across an inner surface of each of the plurality of mate-able sections.

5. The method of claim 1, wherein in the positioning step, at least one of the plurality of mate-able sections is configured with a vacuum port for imparting a suction on the catalyst module.

6. The method of claim 5, further comprising activating the suction and the at least one pneumatic vibrator so that the suction and pneumatic vibrator operate at a common period of time.

7. The method of claim 1, wherein the step for connecting the at least one pneumatic vibrator connects the at least one pneumatic vibrator by one of: bolting, welding and clamping.

8. The method of claim 1, wherein the step for connecting the at least one pneumatic vibrator connects the at least one pneumatic vibrator to a metallic beam under the under the catalyst module.

9. The method of claim 1, wherein the step for connecting the at least one pneumatic vibrator connects a plurality of pneumatic vibrators.

10. A system for cleaning a selective catalytic reduction (SCR) unit during an off-line mode of a SCR system, comprising:
a hood having a plurality of mate-able sections, the hood configured with at least on air line for blowing air and configured to accept a vacuum line, the hood size configured to be positionable to enclose a top of the catalyst module; and
at least one pneumatic vibrator connectable to a frame element of a support system under the catalyst module,
wherein the hood and pneumatic vibrator are configured to operationally clear the catalyst module of built-up particle ash.

11. The system of claim 10, wherein the plurality of mate-able sections are each sized to permit individual entry into the SCR system.

12. The system of claim 10, wherein the plurality of mate-able sections are each sized to permit individual entry into a SCR system, and the mated sections together being too large to permit entry into the SCR system.

13. The method of claim 10, wherein each of the plurality of mate-able sections is configured with at least one air line spanning across an inner surface of each of the plurality of mate-able sections.

14. The system of claim 10, wherein at least one of the plurality of mate-able sections is configured with a vacuum port for imparting a suction on the catalyst module.

15. The system of claim 10, wherein the at least one pneumatic vibrator connects the at least one pneumatic vibrator by one of: bolting, welding and clamping.

19. The system of claim 10, wherein the at least one pneumatic vibrator connects the at least one pneumatic vibrator to a metallic beam under the under the catalyst module.

20. The system of claim 10, wherein the at least one pneumatic vibrator comprises a plurality of pneumatic vibrators.

21. A method for cleaning a selective catalytic reduction (SCR) unit during an on-line or off-line mode of a SCR system, the method comprising:
connecting at plurality of pneumatic vibrators to a support system under a catalyst module; and
activating the at plurality of pneumatic vibrators to clear at least in part the catalyst module of built-up particle ash.

22. The method of claim 21, wherein the plurality of pneumatic vibrators are attached on different beams of the support system.
